(19) United States
(12) Patent Application Publication
(10) Pub. No.: US 2025/0278744 A1
(43) Pub. Date: Sep. 4, 2025

(54) EMISSIONS MANAGEMENT FOR UNAVAILABLE SERVICES

(71) Applicant: Wells Fargo Bank, N.A., San Francisco, CA (US)

(72) Inventors: Dhilip Kumar Mandava, Hyderabad (IN); Naresh Reddy Maram Reddy, Kothagudem (IN); Prita Saha, Hyderabad (IN); Abhishek Singh, Sangareddy (IN); Kiran K. Toram, Hyderabad (IN)

(21) Appl. No.: 18/591,651

(22) Filed: Feb. 29, 2024

(51) Int. Cl. G06Q 30/018

(52) U.S. Cl. CPC G06Q 30/018

(57) ABSTRACT

Managing carbon emissions associated with unavailable services. In the context of financial services, a customer of a financial institution can attempt to access an online provided financial service, only to be denied access to the service due to an access issue with one or more computing systems. Such denials of service can lead to high levels of carbon emissions due to ensuing activity following the initial denial of service, such as repeated attempts to refresh a webpage or messaging customer service. By contextualizing the denial of service and predicting relative magnitudes of carbon emissions associated with different service access pathways for providing the denied service to the customer, overall carbon emissions can be reduced.

### BACKGROUND

Financial institutions increasingly offer and rely on online banking services for their customers as such services are typically more convenient to the customers and easier to operate. Due to widespread and increasing usage of online banking, there is a significant rise in denial-of-service occurrences while customers are accessing banking services. Customer activity in response to such denials of service can result in significant carbon emissions.

### SUMMARY

In general terms, the present disclosure is directed to managing carbon emissions resulting from unavailable services. Services can be made unavailable by, e.g., a denial of service.

In further general terms, the present disclosure is directed to predicting magnitudes of carbon emissions associated with different potential service access pathways that could ensue following a denial-of-service occurrence.

In further general terms, the present disclosure is directed to providing customers with alternate ways of accessing a given service following a denial of that service, where the alternate ways are generated and/or ranked based on predicted, relative carbon emissions associated with each one.

In further general terms, the present disclosure is directed to preemptively alerting a customer who has not yet attempted to access a service about an unavailability of that service.

An aspect of the present disclosure relates to a computing system for managing carbon emissions associated with unavailable services, the computing system including: a processor; and memory encoding instructions which, when executed by the processor, cause the computing system to: detect access unavailability to an online version of a service at a computing device; determine a computing issue causing the access unavailability; predict, based on the issue, a first carbon emissions score correlated to a predicted magnitude of carbon emissions that would be emitted to resolve the issue and provide access to the online version of the service at the computing device; predict a second carbon emissions score correlated to a predicted magnitude of carbon emissions that would be emitted to provide access to another version of the service; and perform an action based on the first carbon emissions score and the second carbon emissions score.

Another aspect relates to a computing system for managing carbon emissions associated with unavailable services, the computing system including: a processor; and memory encoding instructions which, when executed by the processor, cause the computing system to: detect access unavailability to an online version of a service at a computing device, the access unavailability being associated with a first account; predict a future attempted access to the online version of the service with a second account; and generate, in response to the access unavailability being detected and before the attempted access, an alert; and provide the alert to the second account, the alert indicating that the online version of the service is unavailable.

Yet another aspect relates to computer-implemented method for managing carbon emissions associated with unavailable services, the method including: detecting access unavailability to an online version of a service at a computing device, the detecting including receiving first signals generated by the online version of the service indicating that a denial of service has occurred, with the first signals being generated automatically upon an attempted access of the online version of the service by the computing device; determining a computing issue causing the access unavailability, including receiving second signals generated by the online version of the service indicating a type of the computing issue, the type of the computing issue including one of: a website error, a server overload, a database error, or a mobile application error; predicting, based on the type of computing issue and using artificial intelligence, a first carbon emissions score correlated to a predicted magnitude of carbon emissions that would be emitted to resolve the issue and provide access to the online version of the service at the computing device; predicting, using the artificial intelligence, a second carbon emissions score correlated to a predicted magnitude of carbon emissions that would be emitted to provide access to another version of the service; and generating, based on the first carbon emissions score and the second carbon emissions score, third signals configured to cause an interface at the computing device to be generated, the interface displaying at least two options for accessing the service and further displaying indicia indicating relative carbon emissions magnitudes associated with executing different ones of the at least two options, one of the at least two options being to access the another version of the service.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example emissions management system for unavailable services.

FIG. 2 shows an example emissions management method that can be performed by the system of FIG. 1.

FIG. 3 shows a further example emissions management method that can be performed by the system of FIG. 1.

FIG. 4 shows an example user interface that can be generated by the system of FIG. 1.

FIG. 5 shows a further example user interface that can be generated by the system of FIG. 1.

FIG. 6 shows example physical components of portions of the system of FIG. 1.

### DETAILED DESCRIPTION

With the increase of online services such as online banking services, instances of services being unavailable are increasing. In a typical scenario, a customer of a financial institution may attempt to access a particular online banking service, e.g., to pay a credit card, to transfer funds between accounts, to make a wire payment, and the like. If that version of the banking service is unavailable, a denial-of-service (DOS) occurs. Denials of service can upset customers, harm customers, and harm the reputation of the enterprises that provide the services.

As used herein, a customer can be any consumer of online services provided by another entity or enterprise. An example of an enterprise is a financial institution that offers online banking services, such as services that provide access to various transaction accounts and other bank accounts of the customer, services that allow customers to transfer funds, to make payments, to make trades, to apply for loans, to service loans, and the like. A customer can be an individual, a corporation, or the like. For example, a customer can be a company that relies on the financial institution's online payment service to pay its employees every two weeks. As another example, a customer can be an individual who relies on the financial institution's online credit card account service to view credit card statements and transaction activity, and to pay their credit card bill each month.

A DoS can occur, for example, as a result of a website error, a server overload, a backend database error, a mobile application error, a cyberattack, and the like. In some examples, a notification about the DoS occurrence may be displayed to the customer via an online portal being accessed by the customer's user device when the customer attempts to access a banking service.

Activity following the notification of the DoS can result in significant carbon emissions. Generally, such emissions result from the processing load on computing and banking resources, such as back-end servers and databases that expend energy to power their hardware and prevent the hardware from overheating. For example, a customer may refresh a banking portal multiple times until the DoS issue is resolved, resulting in higher carbon emissions, as each time the customer initiates a refresh there is a significant load on the financial institution's banking resources, servers, server management facilities, and the like. This can be exacerbated because of the scale of such systems, which typically services hundreds or thousands of customers at a given time.

Such emissions can also result from engagement with customer service representatives who generate emissions by, for example, the computing resources used to generate and send the representative a communications regarding the DoS, by the representatives' commuting to an office or other place of work, by the computing devices and communications devices the representatives use for their jobs, by the energy expended at the worksite of the customer service representatives, e.g., to control the climate at the facility where the customer service representatives work, and the like. For example, a customer may have to navigate multiple online pages to report the DoS to the bank's online assistant or customer service agent, resulting in significant carbon emissions.

Further significant carbon emissions arise due to customers, who are unaware of the DoS issue, attempting and failing to access the same version of the banking service that has the issue.

Aspects of the present disclosure advantageously manage, mitigate, minimize, and/or optimize carbon emissions associated with service unavailability, such as DoS issues, based on various factors associated with the service unavailability and the user and/or potential users that have attempted to, or may attempt to, access the service. The combination of any number of such factors is referred to herein as the context of the service unavailability or DoS issue. As a result, the carbon footprints of users (e.g., customers) of the service and providers (e.g., a financial institution) of the service can be minimized and/or optimized according to the context of the unavailability.

According to an embodiment of the present disclosure, minimization and/or optimization of carbon emissions resulting from service unavailability is performed by transmission, receipt, and processing of particular signals by different computing devices. For example, a customer accesses an online banking service via a mobile computing device. The online banking service is unavailable due to a DoS issue. The online banking service, e.g., a mobile application, automatically generates and transmits signals including data that identify aspects of the DoS, such as the context of the DoS.

Those signals are received by a backend server that processes the signals and predicts, based on the information contained in the signals, carbon emissions associated with different potential service access pathways that could stem from the DoS issue. For instance, the signals received by the backend service identifying a DoS issue can be processed by the backend server to predict the computing power needed, and corresponding carbon emissions emitted, to process predicted refreshes of the online service webpage or portal page via the mobile computing device in response to the DoS.

The backend server then automatically generates further signals configured to manage the potentially ensuing carbon emissions. For instance, the further signals can be sent to the mobile computing device and cause the mobile computing device to automatically generate an interface that provides different options for working around or otherwise dealing with the DoS. As another example, the further signals can cause the server to automatically identify other customers that may potentially attempt to access the unavailable service, and the further signals are sent to message boards of financial accounts associated with those identified customers, automatically generating alerts in the message boards about the DoS.

These and other examples herein are technological improvements specifically within the technological field of online services. The improvements relate to, among other things, computing systems that can identify and process online service unavailability automatically in response to the occurrence of DoS issue in online access to services, advantageously resulting in reduced expenditure of computing resources and processing power and lower carbon emissions for online services. In certain examples, these improvements are achieved with specially tailored signals generated, transmitted and/or received by different computing devices.

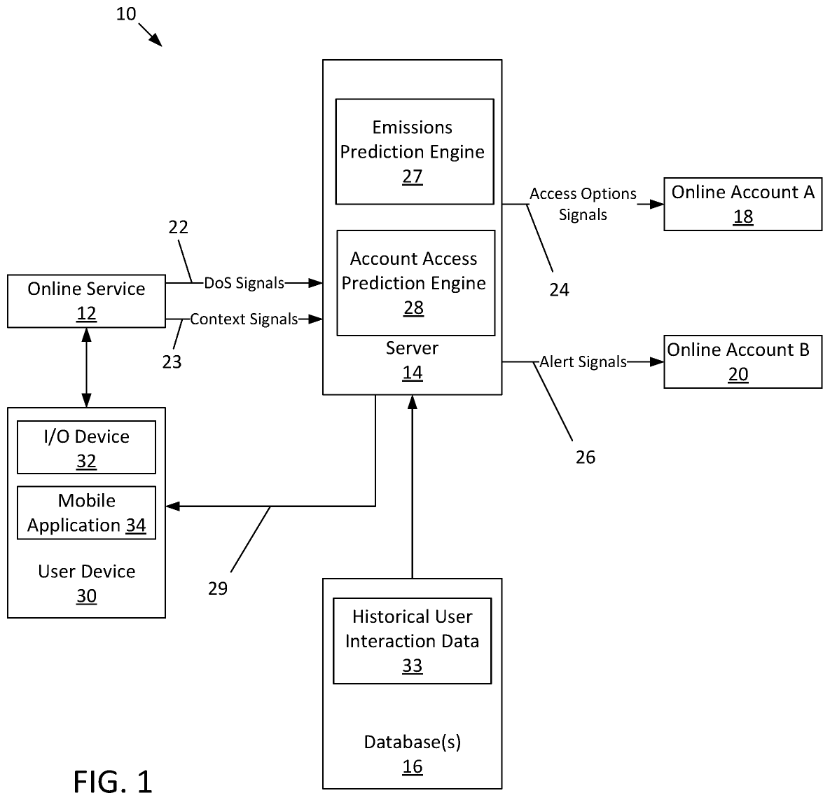

FIG. 1 shows an example emissions management system 10 for unavailable services in accordance with the present disclosure.

The system 10 includes a server 14 and a user device 30, each of which can include a processor and non-transitory computer readable storage storing instructions executable by the processor to perform functions described herein.

The various components of the system 10 can be networked together via any suitable network or combination of networks for operably coupling computing devices to one another so that the computing devices can communicate computing signals between one another.

The user device 30 can be, for example, a smartphone, a tablet, a smartwatch or other smart wearable technology, a virtual reality device, an augmented reality device, a desktop computer, a computing terminal at physical branch of an enterprise (e.g., a bank), an automatic teller machine (ATM), a point of sale (POS) payment terminal, and the like.

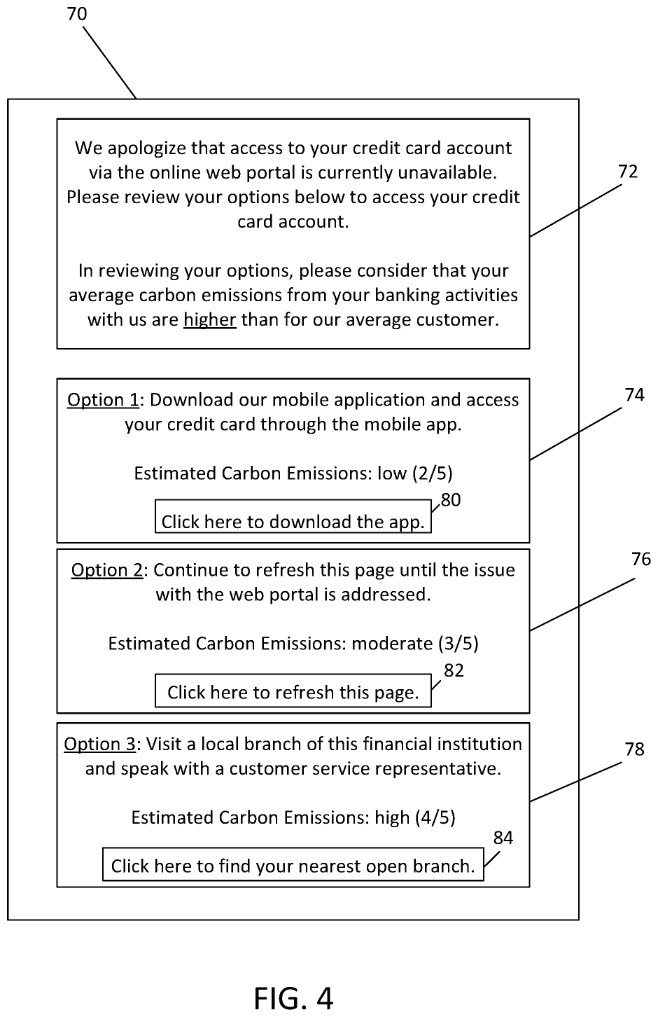

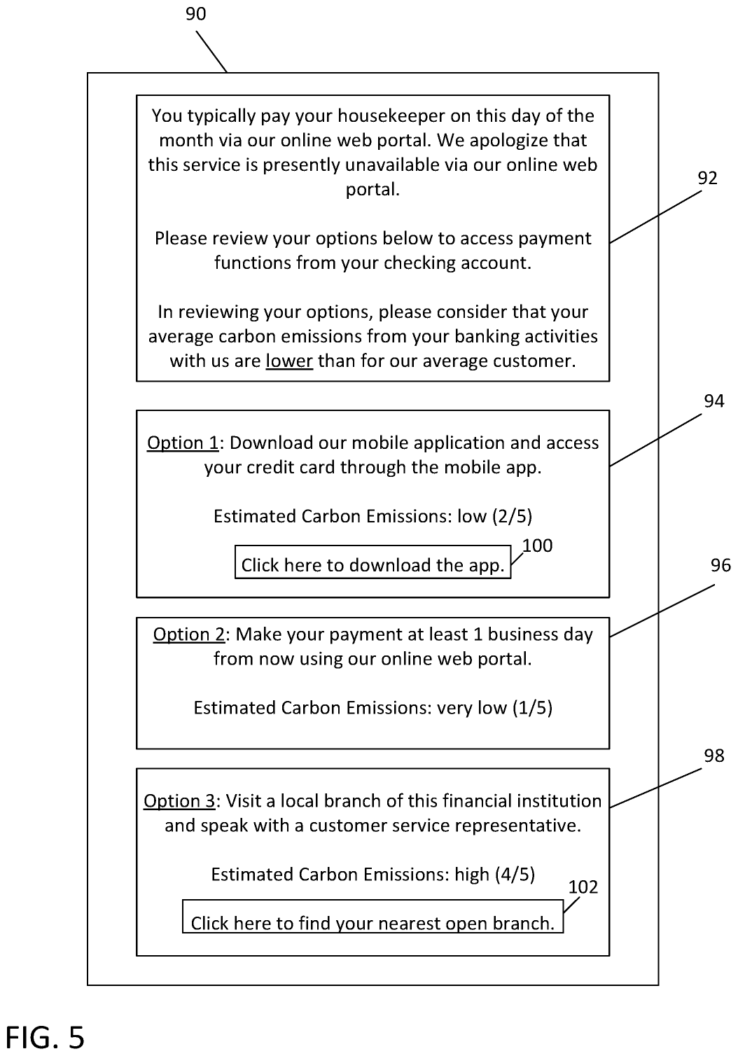

The user device includes in input/output (I/O) device 32 and a mobile application 34 locally stored on non-transitory computer-readable storage of the user device 30. The I/O device 32 can include, for example, one or more of a display, a touch screen, a microphone, a speaker, a keypad, a mouse, a stylus, and the like. For example, a display or touchscreen of the I/O device can display user interfaces described herein and receive user input, such as the interfaces of FIGS. 4 and 5.

The mobile application 34 can be a software application that provides access to one or more online services provided by an entity, such as a financial institution. For instance, the mobile application 34 can be a banking application that provides access, upon entering of proper credentials, to a user's bank and transaction accounts that are provided by a particular financial institution, and services associated with those accounts, such as services that allow payments, transfers, trades, loans, downloading of statements, viewing of transaction activity, and the like.

The server 14 can represent a single server, e.g., that is operated exclusively by a financial institution. Alternatively, the server 14 can include multiple computing devices, with the functionality of the server 14 being distributed across the multiple computing devices using a network. For instance, the server 14 can represent a computing cloud that a financial institution accesses to perform functions of the server 14 described herein.

The server 14 can be configured to use artificial intelligence, such as a neural network, to perform various functions described herein. Such artificial intelligence can be trained to generate and modify algorithms that make predictions as described herein, all based on various input data. The artificial intelligence can be trained using human input, trained without using human input, and/or trained by a combination of self-training without human-input and training with human input. For instance, the server 14 can store on non-transitory computer readable storage, or otherwise access via a network, an emissions prediction engine 27 and an account access prediction engine 28. Each of these engines 27 and 28 can include one or more machine learning models trained and configured to make predictions for management of emissions associated with unavailable services, as will be described more herein.

The system 10 includes a database 16. In examples, the database 16 can represent multiple databases, e.g., distributed databases. The database stores data that can be processed by the server 14, including the engines 27 and 28. For example, in the case of a financial institution, the database 16 can store account information for various financial accounts and transaction accounts of the financial institution's customers. The database 16 can also store profile information about the customers themselves, such as contact information, preferences, and any service history the customer has had with the financial institution, such as records of all transactions and other actions conducted by the customer when logged into their financial accounts, records of all communications between the customer and the financial institution, records of all complaints and comments lodged by the customer with the financial institution, and the like.

The database 16 can store records of customers' history of interactions with the financial institution following a DoS, as well as records containing data that describe the type of service that was denied by the DoS. Examples of type of service records can include, for example, an account access service, a transaction account statement access service, a payment service, a money transfer service, a cash withdrawal service, a check deposit service, etc. Additional records can indicate the cause of each DoS, such as an error with a particular piece of hardware or software, an error with a network or a particular portion of a network, a server overload, etc. Additional records can indicate when each DoS occurred. Additional records can indicate how the customer reacted to the DoS, for example, by refreshing a webpage a certain of times, sending a complaint to the financial institution, and the like. Additional records can indicate when the DoS was resolved and how the DoS was resolved. Additional records can indicate how the customer ultimately accessed the service that had been denied, such as by waiting for the denied version of the service to come back online, accessing a different version of the service (including an indication as to what the different version is), or giving up.

The customer history data can also include an historical carbon score for the user that correlates to an amount of carbon emitted as a result of that user's use of services provided by the enterprise. For example, a customer who accesses their online bank account multiple times a day, has a history of refreshing web pages more than five times when encountering a DoS, and of emailing complaints to the financial institution and posting complaints to social media when encountering a DoS, may have a higher carbon score than a customer who accesses their online bank account once a month and has never encountered a DoS. All of these data can be stored in the database 16 as historical user interaction data 33.

With respect to the customer's reaction to the DoS, examples of the data stored on the database 16 can include a record of the number of times a customer attempted to refresh a webpage in response to a DoS, a record that the customer visited a branch of the financial institution and met with an agent of the financial institution as a result of the DoS, a record that the customer sent an email or other electronic communication to the financial institution complaining about the DoS, a record that the customer posted a complaint about the financial institution on social media in response to the DoS, and records of any responses by the financial institution to the customer's reaction to the DoS, such as records of electronic communications being generated and sent to the customer in response to communications from the customer about the DoS.

Via a network, the user device 30 accesses an online service 12 that is provided by the server 14. In the case of a financial institution, for example, the online service 12 can be any banking service that a customer of the financial institution may have access to, such as an account access service, a transaction account statement access service, a payment service, a money transfer service, a cash withdrawal service, a check deposit service, and the like.

The online service 12 can be accessed in different ways. For example, the online service 12 can be accessed via the mobile application 34 using the user device 30. A user (e.g., a customer of a financial institution) logs into the mobile application to access the online service 12.

In another example, the online service 12 can be accessed, using the user device 30, via a web portal or website of the financial institution or other enterprise. For example, a user navigates on the user device 30 in a web browser to a website of their financial institution, logs into the online portal, and thereby accesses the online service 12.

In other example the user device 30 is an ATM and the online service 12 can be accessed by a user accessing a financial account using the ATM.

The server 14 can provide access to online accounts provided by the enterprise, such as online account A 18 and online account B 20. For example, each account 18, 20 can be a credit card account, a checking account, a savings account, a loan account, an investment account, a mortgage account, and the like.

Data about the accounts 18 and 20 can be stored on the database 16. In this example, the account 18 and the account 20 are associated with different customers of a financial institution.

As mentioned, the accounts 18 and 20 can be accessed by the respective customers associated with them by logging into the accounts, e.g., using the user device 30. The accounts 18 and 20 can be accessed via the mobile application 34 or via a web portal or webpage.

Once an account 18, 20 is accessed, an online service 12 associated with the account can be initiated, provided that the online service 12 is available. For example, if the online account 18 is a credit card account, the online service 12 can be a credit card payment service. The customer can log into their account 18 and initiate the online service 12 to pay their credit card from another account, such as a checking out.

Still referring to FIG. 1 and the system 10, an example scenario will now be described in which the online service 12 is unavailable.

In this scenario, a customer of a financial institution logs into their online account 18, and attempts to initiate the online service 12 associated with the account they have logged into only to find that the online service 12 is unavailable. That is, as result of the customer attempting to initiate the online service 12 (e.g., by selecting a button on an interface to initiate the online service 12), the customer has encountered a DoS with respect to the online service 12.

In response to the occurrence of the DoS, the online service 12 is configured to automatically generate DoS signals 22 and context signals 23. Both of these types of signals 22 and 23 are received by the server 14.

The emissions prediction engine 27 uses artificial intelligence to process the DoS signals 22, the context signals 23, and data from the database 16 to predict emissions scores associated with different possible service access pathways and, ultimately, to generate the access options signals 24 that is transmitted by the server 14 and received by the online account 18.

The result of the access options signals 24 being received by the online account 18 can be the generation of a particular user interface, such as the user interface 70 of FIG. 4 at the I/O device 32 while the user is logged into their account 18.

The DoS signals 22 provides DoS data about the DoS that occurred to the emissions prediction engine 27. Such DoS data can include, for example, an indicator data packet indicating that a DoS occurred and a DoS type data packet indicating the type of service that was denied.

The context signals 23 can provide additional context data related to the DoS. Such context data can be provided in one or more data packets, as payload and/or metadata of such packets. Such additional information can include, for example, when (the date, day of the week, time of day) the DoS occurred, how the service was accessed (e.g., via the mobile application 34, a webpage, an online portal, etc.), how many other occurrences of the DoS have occurred for the online service 12 within a predefined amount of time of signals 23 being received or generated, and an identification of the user or online account that attempted to access the service 12.

In some examples, the emissions prediction engine 27 uses the context data from the context signals 23 to identify a customer who encountered the DoS and then accesses corresponding historical data about that customer from the historical user interaction data 33 stored on the database 16 about the customer's previous interactions with the enterprise and how they have reacted in the past to denials of service.

The emissions prediction engine 27 in some examples uses the DoS data and the context data to generate the access options signals 24. In other examples, the emissions prediction engine 27 uses the DoS data, the context data and the historical data as inputs to generate the access options signals 24 as output.

In particular, the emissions prediction engine 27 is trained to predict based on at least these two or at least these three types of data, likely levels of carbon emissions associated with different possible pathways for the denied user to access the service that has been denied. Based on the same sets of data, the emissions prediction engine 27 then generates and ranks service access options that are provided to the denied user via the access options signals 24. The access pathway options selected by the emissions prediction engine 27 to present to the user and the order in which those options are ranked by the emissions prediction engine 27 can depend on the same sets of data.

With respect to DoS data, for example, unavailability of a payment service (e.g., for a payroll customer) may be considered more critical than unavailability of a service that allows a customer to download a credit card statement.

With respect to context data, for example, the cause of the DoS can be determined or diagnosed. For instance, if the DoS was associated with an attempted access of the online service 12 via a webpage or web portal, the issue causing the DoS is more likely an error with systems supporting the portal than an error with the mobile application 34 or the systems supporting the mobile application 34. If the DoS occurred during the first week of a calendar month and is a denial of a credit card payment type service, the DoS is more likely to be a result of a server overload (due to many customers accessing the same service in the first week of the calendar month) than an error that requires troubleshooting or fixing. If the DoS occurred at a time when traffic to that service is generally slow, the DoS is more likely to be a result of an error in an underlying service supporting system that may take significant time to fix.

If many other instances (e.g., more than a predefined threshold number) of the same type of DoS have occurred to customers within a predefined amount of time since the DoS signals 22, then it is more likely that the underlying cause of the DoS will result in significant overall net carbon emissions than if there are relatively few instances (e.g., less than a predefined threshold number) of the same DoS within that timeframe.

With respect to the historical user interaction data, for example, if the user has a track record of refreshing a web page many times (e.g., more than a predefined threshold number of times) when experiencing a DoS or traveling to a branch of the financial institution when encountering a DoS, then it is more likely that the user will cause significant carbon emissions if not directed to lower emissions access pathway than if the user does not have a history of high carbon emissions in response to DoS.

How access pathways are ranked for the user can depend on the user's historical carbon score. For example, historically higher emitting carbon users may be given options ranked with the lower emissions service access pathways options first, whereas historically lower emitting carbon users may be given options ranked with service access pathways that will result in the quickest access to the denied service first.

The emissions prediction engine 27 is trained to process these types of data and generate the access options signals 24, which includes one or more access service pathway options and associated carbon scores for each option. The carbon score for each option correlates with the predicted amount of carbon emissions from executing that option. The access service pathway options can be selected and ranked according to various factors as described above (as well as other factors) and learned from the various data (including, e.g., the DoS data, the context data, and the historical user interaction data), thereby optimizing the access options signals 24 that is output to the particular customer.

Such factors can include, for example, the level of urgency to provide access to the denied service to customers generally, the level of urgency to provide access to the service to the particular customer whose DoS signals triggered the need to identify alternate service access pathways, the carbon emissions resulting from the customer's predicted reaction to the DoS, whether the customer has an historically low or historically high carbon footprint with respect to use of the enterprise's services, how quickly the underlying issue causing the DoS is likely to be resolved, which is in turn based on the determination or diagnosis of the cause of the DoS issue (e.g., a server overload that is likely to resolve on its own much sooner than a software error caused by a virus from a cyberattack), the availability of alternate service access pathways and the predicted carbon emissions resulting from the customer, or customers generally, resorting to such alternate service access pathways, and the like.

The account access prediction engine 28 is configured to generate the alert signals 26. The alert signals 26 are sent to an online account 20 associated with another customer, i.e., a customer who has not encountered the DoS of the online service 12 that was encountered by the customer who accessed the online account 18.

The online account 20 can represent multiple online accounts that have not yet encountered the DoS of the online service 12 that was encountered by the customer who accessed the online account 18. The alert signals 26 can be sent to each such account 20 and accessed via user devices when the respective customers access their respective accounts 20. Alternatively, the alert signals 26 can generate a notification that can be received at a user device of a user associated with the online account 20 without the user having to actually access the account 20. For example, the notification could be in the form of an email, text message, SMS message, or the like.

The notification generated by the alert signals 26 can include a notice of the online service 12 that is unavailable. The notification generated by the alert signals 26 can also include one or more options of service access pathways to access the denied service based on the processing performed by the emissions prediction engine.

The account access prediction engine 28 is trained to predict which customers are likely to attempt to access the online service 12 and encounter a DoS before the issue causing the DoS is likely to be resolved. To make these predictions, the account access prediction engine 28 can receive the DoS data, the context data described above, as well as the historical data 33 for all customers, or all customers in the same category or classification (e.g., all private individual customers, or all customers who utilize a payroll service) as the customer who has encountered the DoS. The account access prediction engine 28 can also receive, as input, predictive output of the emissions prediction engine 27. All such data can be processed by the account access prediction engine 28 to determine to which customers to send the alert signals 26 and, ultimately, to generate and send the alert signals 26.

For example, based on data input to the emissions prediction engine 27, the emissions prediction engine 27 can predict that the issue causing the DoS is likely to be resolved within one day. This prediction is passed to the account access prediction engine 28. Based on the predicted issue resolution time, and various customers' histories of accessing the service in question during that time of the month, for instance, the account access prediction engine 28 determines a subset of the financial institution's customers who are likely to attempt to access the online service 12 before the online service 12 is predicted to be available again in one day, e.g., before the issue causing the DoS is predicted to be resolved.

The account access prediction engine 28 can also process the historical data 33, the DoS data, and the context data, in a manner similar to the emissions prediction engine, to select customer-specific options and rankings of options for service access pathways to provide, via the alert signals 26, to the customers identified by the account access prediction engine 28 as likely to attempt to access the service 12 before it becomes available again.

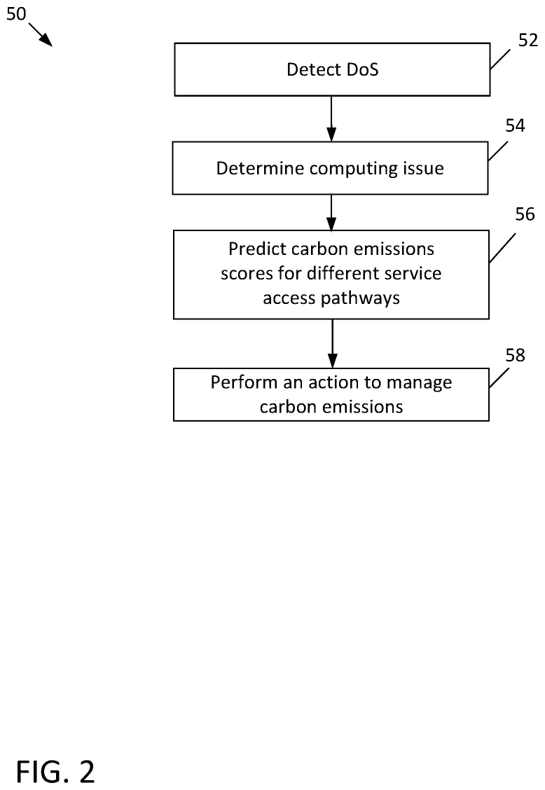

FIG. 2 shows an example emissions management method 50 that can be performed by the system of FIG. 1. The method 50 can be performed by the emissions prediction engine 27 of FIG. 1 based on the DoS signals 22, the context signals 23 and, in some examples, the historical user interaction data 33.

Referring to FIG. 2, at a step 52 of the method 50, a DoS is detected. For example, the emissions prediction engine 27 detects that a DoS has occurred based on receiving the DoS signals 22.

At a step 54 of the method 50, a likely computing issue causing the DoS is determined by the emissions prediction engine 27, e.g., based on receipt of the DoS signals 22 and/or the context signals 23. The computing issue could be, for example, an error in a system, a network, a piece of hardware or software, or simply a server overload due to too many users accessing the server 14 at the same time.

At a step 56 of the method 50, the emissions prediction engine 27 predicts, based on the DoS signals 22, the context signals 23 and, in some examples, the historical user interaction data 33, carbon emissions scores correlated to predicted carbon emissions that would be emitted by the customer who has encountered the DoS as results of different possible access pathways to the service via different versions of the service. For example, at the step 56 it is predicted that the customer will emit approximately twice as much carbon by pursuing a service access pathway involving attempting to refresh the webpage to a portal provided version of the service that the customer has been denied than would be emitted if the customer were instead to pursue a service access pathway involving accessing an alternative version of the service that is provided via a mobile application.

At a step 58 of the method 50, the emissions prediction engine 27 performs an action to manage carbon emissions based on the prediction at the step 56, including the different prediction carbon emissions scores. For example, at the step 58, the emissions prediction engine 27 generates and transmits the access options signals 24, which generates an interface at the customer's user device with information about the DoS and different access pathways to access the service, and information about predicted carbon emissions of each. An example interface generated by the access options signals 24 is shown in FIG. 4.

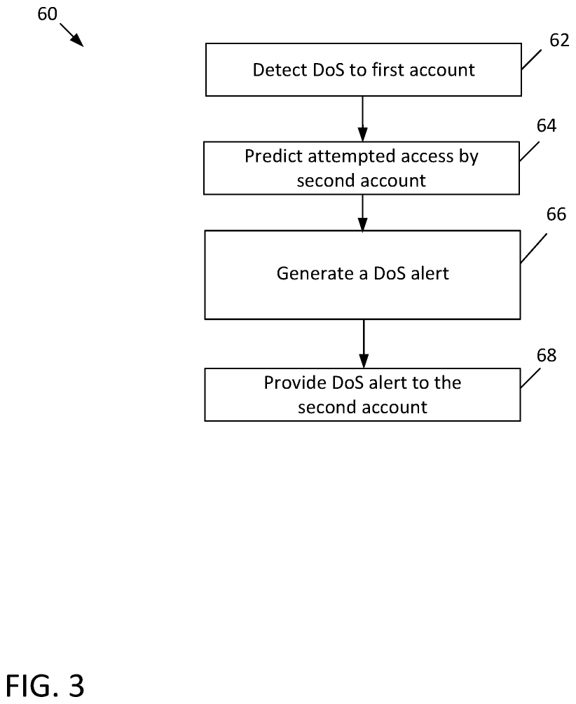

FIG. 3 shows a further example emissions management method 60 that can be performed by the system of FIG. 1. The method 60 can be performed by the account access prediction engine 28 of FIG. 1 based on the DoS signals 22, the context signals 23, the historical user interaction data 33, and the carbon emissions predictions generated by the emissions prediction engine 27. In some examples, steps of the method 60 can be performed by the account access prediction engine 28, or both the account access prediction engine 28 and the emissions prediction engine 27.

At a step 62 of the method 60, a DoS to a first account of a first customer is detected, e.g., based on receipt of the DoS signals 22.

At a step 64 of the method 60, the account access prediction engine 28, based on the context signals 23 and the historical user interaction data 33, predicts that the denied version of the service is likely to be accessed before the issue causing the DoS is likely to be resolved by at least one second customer associated with a second account.

At a step 66 of the method 60, the account access prediction engine 28 generates a DoS alert based on the prediction at the step 64 that there is at least one other account or customer likely to attempt to access the denied version of the service before the issue causing the denial is resolved. The DoS alert is generated in the form of the alert signals 26.

At a step 68 of the method 60, the alert signals 26 are transmitted to the predicted account or otherwise to the customer associated with the predicted account. The alert signals 26 include a notification about the issue that may cause a DoS if access to the denied version of the service is attempted. The alert signals 26 may also include access pathway options to the service, with corresponding carbon emissions predictions for the different pathways. An example of an interface generated by the alert signals is shown in FIG. 5.

FIG. 4 shows an example user interface 70 that can be generated by the system of FIG. 1.

The interface 70 can be generated by, e.g., the I/O device 32 in response to receipt, by the user device 30, of the access options signals 24 when a customer is logged into the online account 18 and has encountered a DoS with respect to the web portal provided version of the online service 12 (FIG. 1).

The interface 70 includes notifications 72. The notifications 72 include an identification of the DoS and an apology for the DoS. The notifications 72 also include an invitation to select one of multiple service access pathway options for accessing the service via different versions of the service. The notifications 72 include a notification that the customer is historically a relatively high carbon emitter for banking activities, and to encourage the customer to select a service access pathway option that is likely to emit less carbon.

The interface 70 also includes three different access pathway options 74, 76, 78. The options 74, 76, 78 can be ranked as described above, e.g., based on the type and urgency of the DoS and the customer's carbon emission history. In this example, the DoS relates to a relatively less important service (credit card account unavailable) and is likely to be resolved quickly (e.g., the DoS issue is likely due to server overload), and the customer is an historically high carbon emitter, and so the options 74, 76, and 78 are ranked according to increasing predicted magnitude of carbon emissions.

Each option 74, 76, 78 describes the service access pathway and provides indicia as to the relative carbon emissions magnitude of selecting that option version another options. For example, the indicia can indicate, for each option, whether the corresponding carbon emissions are very low, low, moderate, high, or very high on a scale of 1 through 5.

One or more of the options 74, 76, 78 can also include, respectively, a mechanism (in this case a selectable button 80, 82, 84) to initiate the service access pathway of the corresponding option. For example, selecting the button 80 initiates the process of downloading the financial institution's mobile application for accessing the mobile application version of the denied service. Selecting the button 82 refreshes the webpage where the DoS has occurred. Selecting the button 84 generates another interface that identifies, for the customer (and based on positioning data of the customer's user device), the location of the nearest open branch that the customer can visit to access an ATM-provided version or customer service representative provided version of the denied service.

FIG. 5 shows a further example user interface 90 that can be generated by the system of FIG. 1.

The interface 90 can be generated by, e.g., the I/O device 32 in response to receipt, by the user device 30, of the alert signals 26, where the customer using the user device 30 is associated with the online account 20 and has not yet attempted, within a predefined period of time (e.g., 2 hours, 12 hours, 24 hours) of the alert signals 26, to access a web portal version of a payment banking service, where such an attempt would likely result, for that customer, in a DoS.

The interface 90 includes notifications 92. The notifications 92 include an explanation for the alert which, in this case, is that it is determined from historical banking activity, that the customer is likely to attempt an online payment today via the financial institution's online portal. The notifications 92 also include an alert that that version of the service is not presently available and an apology for the unavailability. The notifications 92 also include an invitation to select one of multiple service access pathway options for accessing the service via different versions of the service. The notifications 92 include a notification that the customer is historically a relatively low carbon emitter for banking activities, which can help inform the customer's option selection.

The interface 90 also includes three different access pathway options 94, 96, 98. The options 94, 96, 98 can be ranked as described above, e.g., based on the type and urgency of the predicted DoS and the customer's carbon emission history. In this example, the predicted DoS relates to a relatively important service (a payment service) and is unlikely to be resolved quickly (e.g., the DoS issue is likely due to an error in software that runs the online portal), and the customer is an historically low carbon emitter, and so the options 94, 96, and 98 are ranked not according to increasing predicted magnitude of carbon emissions, but rather according to the amount of time expected to gain access to the service via each version or access pathway (the options being ranked according to increasing amounts of time), with relative magnitudes of carbon emissions still being considered, but as secondary factor.

Each option 94, 96, 98 describes the service access pathway and provides indicia as to the relative carbon emissions magnitude of selecting that option version another options. For example, the indicia can indicate, for each option, whether the corresponding carbon emissions are very low, low, moderate, high, or very high on a scale of 1 through 5.

One or more of the options 94, 98 can also include, respectively, a mechanism (in this case a selectable button 100, 102) to initiate the service access pathway of the corresponding option. For example, selecting the button 100 initiates the process of downloading the financial institution's mobile application for accessing the mobile application version of the denied service. Selecting the button 102 generates another interface that identifies, for the customer (and based on positioning data of the customer's user device), the location of the nearest open branch that the customer can visit to access an ATM-provided version or customer service representative provided version of the denied service.

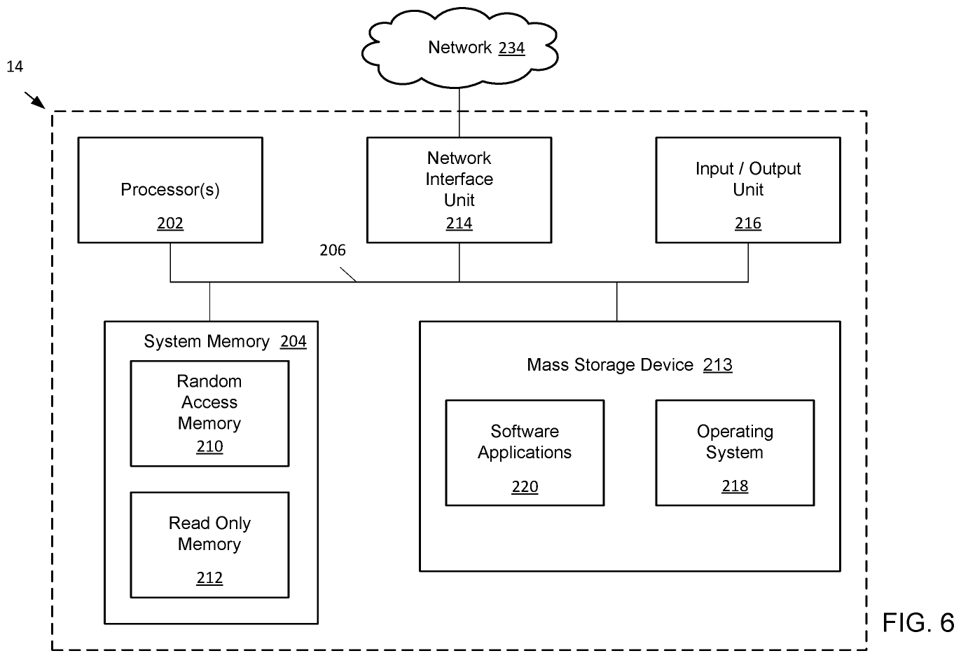

Additional components of the server 14 are illustrated in FIG. 6.

In this example of FIG. 6, the server 14 provides the computing resources to perform at least some of the functionality associated with the system 10 (FIG. 1).

The server 14 can be an internally controlled and managed device (or multiple devices) of an enterprise, e.g., a financial institution that offers various banking services to its customers. Alternatively, the server 14 can represent one or more devices operating in a shared computing system external to the enterprise, such as a cloud. Further, the other computing devices disclosed herein, such as the user device 30 (FIG. 1) can include the same or similar components.

Via the network 234, any components of the server 14 that are physically remote from one another can interact with one another, as well as with other computing resources, such as those shown in FIG. 1. The network 234 can be any suitable wired, wireless, cellular or other data network (or combination of networks) that enables data transmission between computing devices networked together.

The server 14 includes one or more processors 202. The one or more processors 202 are configured to carry out the functionality of the system 10 described above by executing computer-readable instructions stored on non-transitory computer-readable storage. The server 14 also includes a system memory 204 and a system bus 206 that couples the system memory 204 to the processor(s) 202.

The system memory 204 includes a random access memory (“RAM”) 210 and a read-only memory (“ROM”) 212. A basic input/output system that contains the basic routines that help to transfer information between elements within the server 14, such as during startup, is stored in the ROM 212.

The server 14 further includes a mass storage device 213. The mass storage device 213 is able to store software instructions and data such as those required for the emissions prediction engine 27 and account access prediction engine 28 (FIG. 1), as well as to carry out any further functions of the server 14.

The mass storage device 213 is connected to the processor(s) 202 through a mass storage controller (not shown) connected to the system bus 206. The mass storage device 213 and its associated computer-readable data storage media provide non-volatile, non-transitory storage for the server 14. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server 14.

According to various embodiments of the invention, the server 14 may operate in a networked environment using logical connections to remote network devices (such as the user device 30 and the database(s) 16 shown in FIG. 1) through the network 234, such as a wireless network, the internet, or another type of network. The server 14 may connect to the network 234 through a network interface unit 214 connected to the system bus 206. It should be appreciated that the network interface unit 214 may also be utilized to connect to other types of networks and remote computing systems. The server 14 also includes an input/output unit 216 for receiving and processing input from a number of other devices, including a touch user interface display screen, an audio input device, or another type of input device.

As mentioned briefly above, the mass storage device 213 and/or the RAM 210 of the server 14 can store software instructions and data. The software instructions include an operating system 218 suitable for controlling the operation of the server 14. The mass storage device 213 and/or the RAM 210 also store software instructions and applications 220, that when executed by the processor(s) 202, cause the server 14 to provide functionality of the system 10 described above (FIG. 1).

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A computing system for managing carbon emissions associated with unavailable services, comprising:
a processor; and
memory encoding instructions which, when executed by the processor, cause the computing system to:
detect access unavailability to an online version of a service at a computing device;
determine a computing issue causing the access unavailability;
predict, based on the computing issue, a first carbon emissions score correlated to a first predicted magnitude of carbon emissions that would be emitted to resolve the computing issue and provide access to the online version of the service at the computing device;
predict a second carbon emissions score correlated to a second predicted magnitude of carbon emissions that would be emitted to provide access to another version of the service; and
perform an action based on the first carbon emissions score and the second carbon emissions score.

2. The computing system of claim 1, wherein to detect access unavailability includes to receive signals generated by the online version of the service indicating that a denial of service has occurred.

3. The computing system of claim 2, wherein the signals are generated automatically upon an attempted access of the online version of the service by the computing device.

4. The computing system of claim 1, wherein to determine the computing issue includes to receive signals generated by the online version of the service indicating a type of the computing issue.

5. The computing system of claim 4, wherein the type of the computing issue is one of:
a website error;
a server overload;
a database error; and
a mobile application error.

6. The computing system of claim 1, wherein the action includes to generate an interface at the computing device, the interface displaying at least two options for accessing the service and further displaying indicia indicating relative carbon emissions magnitudes associated with executing different ones of the at least two options, one of the at least two options being to access the another version of the service.

7. The computing system of claim 6, wherein the options are ranked based on the relative carbon emissions magnitudes.

8. The computing system of claim 6, wherein the options are ranked based on a type of the service.

9. The computing system of claim 1, wherein the memory encodes further instructions which, when executed by the processor, cause the computing system to:
predict a number of instances of access unavailability to the online version of the service at computing devices due to the computing issue,
wherein the first carbon emissions score is predicted based on the number of instances.

10. The computing system of claim 9, wherein the number of instances is predicted based on when, in a predefined banking cycle, the access unavailability to the online version of the service at the computing device occurred.

11. The computing system of claim 9, wherein the first carbon emissions score and the second carbon emissions score are predicted using artificial intelligence.

12. The computing system of claim 1, wherein the first carbon emissions score is predicted based on prior activity in response to one or more prior instances of service unavailability on an account associated with the access unavailability to the online version of the service.

13. The computing system of claim 1, wherein the access unavailability to the online version of the service is associated with a first account;
wherein the memory encodes further instructions which, when executed by the processor, cause the computing system to predict a future attempted access to the online version of the service with a second account; and
wherein the action includes to generate an alert and provide the alert to the second account, the alert indicating that the online version of the service is unavailable.

14. The computing system of claim 13, wherein the alert includes at least two options for accessing the service and indicia indicating relative carbon emissions magnitudes associated with executing different ones of the at least two options, one of the at least two options being to access the another version of the service.

15. The computing system of claim 1, wherein the first carbon emissions score is predicted based on a predicted number of times that a webpage will be refreshed.

16. A computing system for managing carbon emissions associated with unavailable services, comprising:
a processor; and
memory encoding instructions which, when executed by the processor, cause the computing system to:
detect access unavailability to an online version of a service at a computing device, the access unavailability being associated with a first account;
predict a future attempted access to the online version of the service with a second account;
generate, in response to the access unavailability being detected and before the attempted access, an alert; and
provide the alert to the second account, the alert indicating that the online version of the service is unavailable.

17. The computing system of claim 16, wherein the alert includes at least two options for accessing the service and indicia indicating relative carbon emissions magnitudes associated with executing different ones of the at least two options, one of the at least two options being to access another version of the service.

18. The computing system of claim 16, wherein to predict the future attempted access is based on a history of access to the service with the second account.

19. The computing system of claim 16,
wherein to detect access unavailability includes to receive a signal generated by the online version of the service indicating that a denial of service has occurred; and
wherein the signal is generated automatically upon an attempted access of the online version of the service by the computing device using the first account.

20. A computer-implemented method for managing carbon emissions associated with unavailable services, comprising:
detecting access unavailability to an online version of a service at a computing device, the detecting including receiving first signals generated by the online version of the service indicating that a denial of service has occurred, with the first signals being generated automatically upon an attempted access of the online version of the service by the computing device;
determining a computing issue causing the access unavailability, including receiving second signals generated by the online version of the service indicating a type of the computing issue, the type of the computing issue including one of: a website error, a server overload, a database error, or a mobile application error;
predicting, based on the type of the computing issue and using artificial intelligence, a first carbon emissions score correlated to a first predicted magnitude of carbon emissions that would be emitted to resolve the computing issue and provide access to the online version of the service at the computing device;
predicting, using the artificial intelligence, a second carbon emissions score correlated to a second predicted magnitude of carbon emissions that would be emitted to provide access to another version of the service; and
generating, based on the first carbon emissions score and the second carbon emissions score, third signals configured to cause an interface at the computing device to be generated, the interface displaying at least two options for accessing the service and further displaying indicia indicating relative carbon emissions magnitudes associated with executing different ones of the at least two options, one of the at least two options being to access the another version of the service.
